(19) United States
(12) Patent Application Publication
(10) Pub. No.: US 2008/0310185 A1
(43) Pub. Date: Dec. 18, 2008

(54) ADDRESSABLE LIGHTING ELEMENT FOR A MOBILE COMMUNICATION DEVICE

(75) Inventors: Manuel Oliver, Scottsdale, AZ (US); Claudia Jensen, Mesa, AZ (US); Rick Latella, Woodstock, IL (US); Yi Wei, Chandler, AZ (US); Sen Yang, Palatine, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/763,647

(22) Filed: Jun. 15, 2007

(51) Int. Cl. F21V 8/00

(52) U.S. Cl. 362/602

(57) ABSTRACT

An apparatus that provides lighting for a user interface in a mobile communication device is disclosed. The apparatus may include a planar lightguide, at least one light source located adjacent to the planar lightguide, a plurality of optical structures having at least a first section of optical structures disposed on the surface of the planar lightguide and a second section of optical structures disposed on the surface of the planar lightguide separate from the first section of optical structures, wherein the first section of optical structures is configured to cause a first boundary behavior of light associated with the bending of light paths, and the second section of optical structures is configured to cause a second boundary behavior of light associated with the bending of light paths.

### BACKGROUND OF THE DISCLOSURE

1. Field of the Disclosure

The disclosure relates to displays for mobile communication devices.

2. Introduction

It is desirable to change the appearance of the exterior of a mobile communication device for functional or appearance reasons. One of the key drivers for mobile communication devices is morphable interfaces that change the number or type of buttons on the exterior of a mobile device as the use case (phone, camera, music player) changes. This can be accomplished by using low resolution or segmented display technologies. These could include liquid crystal, electrophoretic, and organic LED, among others. However, these methods require electrodes and active materials to be deposited in these regions. What is needed is a lighting scheme that allows the same functionality to be achieved with a low cost structure.

### SUMMARY OF THE DISCLOSURE

An apparatus that provides lighting for a user interface in a mobile communication device is disclosed. The apparatus may include a planar lightguide, at least one light source located adjacent to the planar lightguide, a plurality of optical structures having at least a first section of optical structures disposed on the surface of the planar lightguide and a second section of optical structures disposed on the surface of the planar lightguide separate from the first section of optical structures, wherein the first section of optical structures is configured to cause a first boundary behavior of light associated with the bending of light paths, and the second section of optical structures is configured to cause a second boundary behavior of light associated with the bending of light paths.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an diagram of an exemplary mobile communication device in accordance with a possible embodiment of the disclosure;

FIG. 2 is a block diagram of an exemplary mobile communication device in accordance with a possible embodiment of the disclosure;

FIGS. 3A-3C illustrate an exemplary lighting system for a user interface in accordance with a possible embodiment of the disclosure;

FIGS. 4A-4C illustrate another exemplary lighting system for a user interface in accordance with a possible embodiment of the disclosure; and

FIG. 5 is an exemplary flowchart illustrating one possible process of fabricating a user interface in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure.

This disclosure concerns an addressable lighting element for a user interface in a mobile communication device. In particular, a single layer planar lightguide may be created that is addressable either by wavelength or geometry. In the wavelength addressable scheme, the outcoupling of light may be created by diffractive or holographic optical structures. By choosing the grating spacing appropriately, only selected areas will be illuminated perpendicular to the planar lightguide when a particular wavelength light source such as an LED is illuminated.

By using multiple light sources of differing input angles, an addressable lighting element may also be created. This addressing scheme is achieved by using directional outcoupling of light where parallel optical structures (diffractive, refractive, or reflective) are oriented largely perpendicular to a predominantly collimated light source. By using different orientations of the optical structures, an addressable lighting element is created.

The disclosure solves the problem of achieving a thin, inexpensive means of changing the user interface or decorative features of an electronic device. Other means of achieving this effect such may employ active display technologies such as liquid crystal, electrophoretic, electroluminescent, etc. These methods require structures such as electrodes and active materials to be incorporated in the region where the interface will be changing. A passive diffractive approach which could be embossed on a single sheet of plastic is potentially lower cost and may also provide greater design freedom. For example, the plastic sheet may be sufficiently thin so that it is flexible.

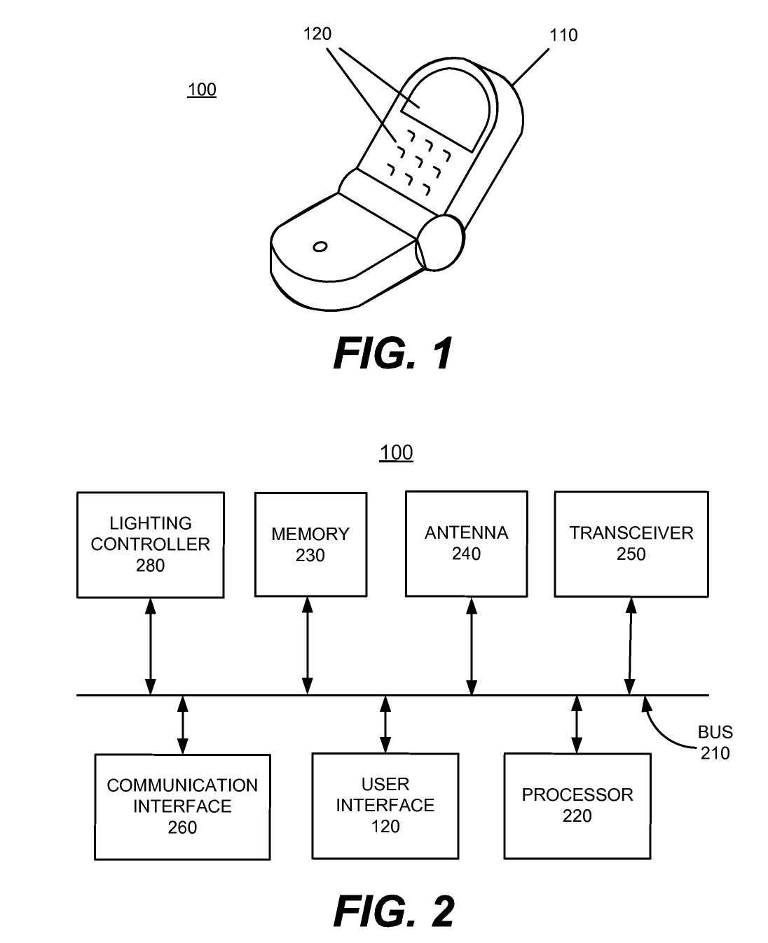

FIG. 1 illustrates an exemplary mobile communication device 100 in accordance with a possible embodiment of the disclosure. In particular, the mobile communication device 100 may include a casing 110 and a user interface 120.

The mobile communication device 100 may be a portable MP3 player, satellite radio receiver, AM/FM radio receiver, satellite television, portable music player, portable laptop, portable computer, e-book, wireless radio, wireless telephone, portable digital video recorder, cellular telephone, mobile telephone, or personal digital assistant PDA), combinations of the above, for example.

The casing 110 may be made at any durable material synthetic or metal capable of housing components of the mobile communication device 100. User interface 290 may include one or more conventional input mechanisms that permit a user to input information, communicate with the mobile communication device 100, and/or present information to the user, such as a an electronic display, microphone, touchpad, keypad, keyboard, mouse, pen, stylus, voice recognition device, buttons, one or more speakers, etc.

FIG. 2 illustrates a block diagram of an exemplary mobile communications device 100 in accordance with a possible embodiment of the invention. The mobile communications device 100 may include a bus 210, a processor 220, a memory 230, an antenna 240, a transceiver 250, a communication interface 260, a lighting controller 280, and a user interface 120. Bus 210 may permit communication among the components of the mobile communication device 100.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support operations within the communications network. The transceiver 250 transmits and receives transmissions via one or more of the antennae 240 in a manner known to those of skill in the art.

Communication interface 260 may include any mechanism that facilitates communication via the network 110. For example, communication interface 260 may include a modem. Alternatively, communication interface 260 may include other mechanisms for assisting the transceiver 250 in communicating with other devices and/or systems via wireless connections.

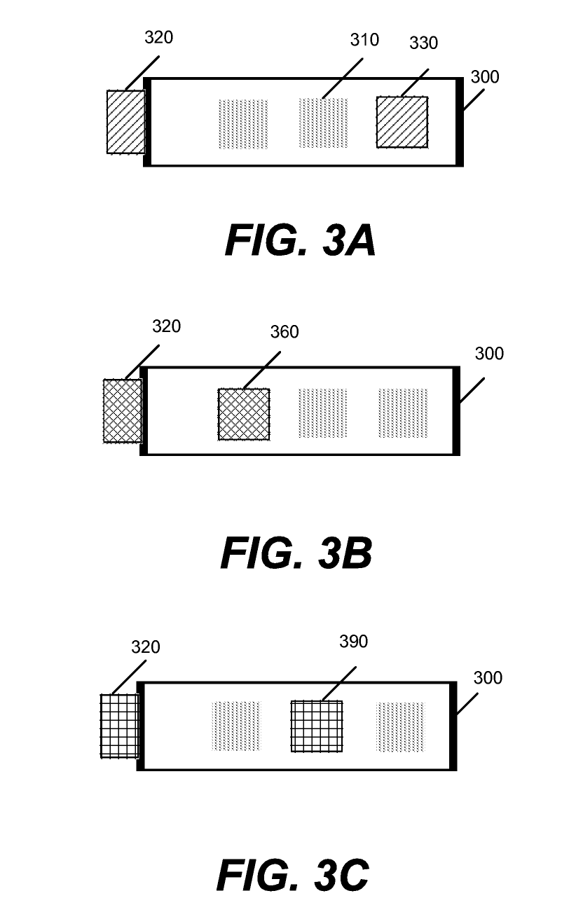

The user interface 120 is described above with respect to FIG. 1 and will be described further below with respect to FIGS. 3-5. The lighting controller 280 controls the lighting functions of the mobile communication device 100 including the lighting of the user interface 120. The lighting controller 280 may control a plurality of light sources for the user interface. In this manner, the lighting controller 280 may determine which one(s) of the plurality of light sources should be illuminated to cause various images to appear on the user interface 120. These images may be buttons or different style, type, function, etc., instructions, information, icons, or other images that may be know to one of skill in the art. One of skill in the art may also appreciate that the functions of the lighting controller 280 and the processor 220 may be performed interchangeably.

The mobile communication device 100 may perform such functions in response to processor 220 and lighting controller 280 by executing sequences of instructions contained in a computer-readable medium, such as, for example, memory 230. Such instructions may be read into memory 230 from another computer-readable medium, such as a storage device or from a separate device via communication interface 260.

FIGS. 3A-3C illustrate an exemplary lighting system for a user interface in accordance with a possible embodiment of the disclosure. FIG. 3A. illustrates a planar lightguide 300 having one or more optical structures 310 attached or integrated thereto. The optical structures 310 may be diffractive or holographic structures such as linear gratings, for example. Located adjacent to the planar lightguide 300 is a multiple wavelength light source 320. When a particular wavelength of light (i.e., color) is emitted from the light source 320, a certain portion of the planar lightguide 300 may be illuminated perpendicular to the surface.

For example, in FIG. 3A, the light source 320 emits a light at a particular wavelength identified by the slanted lines. As a result, optical structure 330 is illuminated. In FIG. 3B, the light source 320 emits a light at another particular wavelength identified by the hashed lines. As a result, optical structure 360 is illuminated. In FIG. 3C, the light source 320 emits a light at another particular wavelength identified by the gridded lines. As a result, optical structure 390 is illuminated. In this instance, this effect may be the result of different spacing of the grating lines, for example. In FIGS. 3A-3C the optical structures are shown physically separated from one anther. It may be desirable to have the optical structures overlap by placing the structures on both the top and bottom of the planar lightguide 300 or by physically interleaving the optical structures. One of skill in the art would recognize that many other optical techniques may be used within the spirit and scope of the invention.

With regard to the grating spacing, from the conservation of momentum, the grating equation may be given by,

mλ=d{n_{w.g.} sin θ_{inc}+nₒᵤₜ sin θₒᵤₜ},

where m in an integer, λ is the wave length, d is a grating period, n_{w.g} is refraction index of the wave guide material, nₒᵤₜ is that of outside (e.g., air=1), θ_{inc} is the incident angle from the wave guide side and θₒᵤₜ is the out-coupling angle. O_{inc} is larger than the critical angle ow lightguide: θ_{c}=sin⁻¹(nₒᵤₜ/n_{w.g})˜42°.

Even for small periodicity grating (thus limited range of m), it is possible to satisfy the above equation for the same θ_{inc} but different λ.

For example, d=500 nm, θ_{inc}=60° and n_{w.g}=1.5 give θₒᵤₜ=36.8°, −17.4°, 0.1° for λ=350 nm, 500 nm and 650 nm, respectively. In this case, the order is limited to m=1 for all λ (for a large d, multiple m thus multiple θₒᵤₜ will be possible). Therefore, it is possible to extract light having different wavelength from the planar lightguide 300 by the grating having the same periodicity. Conversely, light having the same wavelength can be extracted out of the planar lightguide 300 by grating having different periodicity.

Thus, a spec based on the grating period alone gives selectivity only in the out-coupling angle θₒᵤₜ. Out-coupling selectivity among the different wavelength will exist only at the fixed viewing angle.

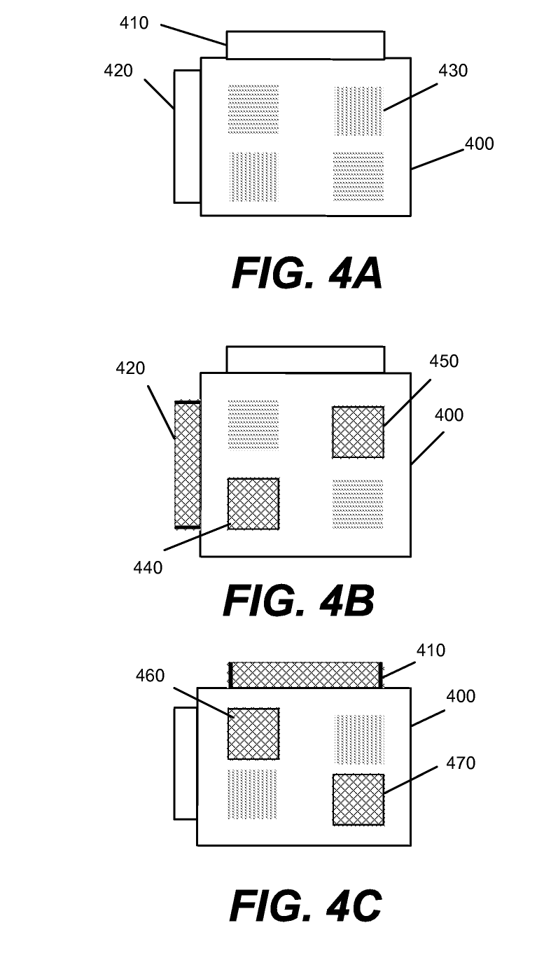

FIGS. 4A-4C illustrate another exemplary lighting system for a user interface in accordance with a possible embodiment of the disclosure. FIG. 4A. illustrates a planar lightguide 400 having one or more optical structures 430 attached or integrated thereto. The optical structures 430 may be diffractive, refractive, or reflective structures such as gratings, for example.

Located adjacent to the planar lightguide 400 are light sources 410, 420. Light sources 410, 420 may be arranged perpendicular to each other. The optical structures 430 are positioned with different orientations to the light sources 410, 420 so that the light will be emitted parallel to some of the grating lines and perpendicular to others. The geometric orientation of the optical structures 430 illuminates different portions of the planar lightguide 400.

By way of example, FIG. 4B shows light source 420 emitting light which illuminates optical structures 430, 440. FIG. 4C shows light source 410 perpendicular to light source 420 emitting light which illuminates different optical structures 450, 460. Other arrangements, for example where three light sources illuminate the planar lightguide 400 and each pair is separated by 60 degrees, are possible.

Note that one of skill in the art may appreciate that additional optical layers may be present above or below the planar lightguide 300, 400 in accordance with the spirit and scope of the invention. For example, additional layers on the top may serve help to change the appearance of the emitted light by diffusing it, changing the viewing angle, etc. Additional layers below the diffractive display may serve to absorb or reflect light from the planar lightguide 300,400, for example. Both the top and bottom layers may be directly bonded to the planar lightguide 300, 400, or have an intervening air gap, for example.

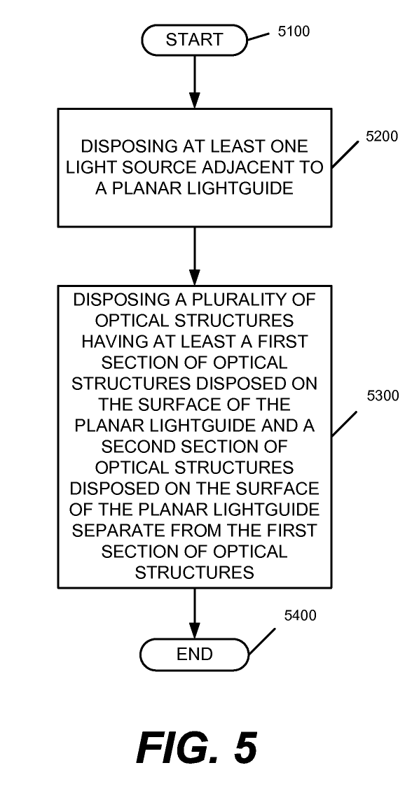

FIG. 5 is an exemplary flowchart illustrating some of the basic steps associated with a user interface fabrication process in accordance with a possible embodiment of the disclosure. The process begins at step 5100 and continues to step 5200 where the process disposes at least one light source 310, 410, 420 adjacent to the planar lightguide 300, 400.

At step 5300, the process disposes a plurality of optical structures 310, 430 having at least a first section of optical structures disposed on the surface of the planar lightguide and a second section of optical structures disposed on the surface of the planar lightguide separate from the first section of optical structures. Note that more than two sections may exist on the planar lightguide within the spirit and scope of the invention.

For example, in FIG. 3A-3C, optical structures 330, 360, and 390 may each be considered different optical structure sections within the spirit and scope of the invention. In FIG. 4A-4C, the top right 450 and bottom left 440 optical structures 430 may be one section and the top left 450 and bottom right 460 optical structures 430 may be another section, for example. As one of skill in the art may appreciate, the number of optical structure sections and their arrangement on the planar lightguide 300, 400 may vary within the spirit and scope of the invention.

The first section of optical structures may be configured to cause a first boundary behavior of light associated with the bending of light paths, and the second section of optical structures may be configured to cause a second boundary behavior of light associated with the bending of light paths. The process goes to step 5400, and ends.

038 Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. It does not necessarily need to be one system used by all end users. Accordingly, the appended claims and their legal equivalents should only define the disclosure, rather than any specific examples given.

We claim:

1. An apparatus that provides lighting for a user interface in a mobile communication device, comprising:
a planar lightguide;
at least one light source located adjacent to the planar lightguide; and
a plurality of optical structures having at least a first section of optical structures disposed on the surface of the planar lightguide and a second section of optical structures disposed on the surface of the planar lightguide separate from the first section of optical structures;
wherein the first section of optical structures is configured to cause a first boundary behavior of light associated with the bending of light paths, and the second section of optical structures is configured to cause a second boundary behavior of light associated with the bending of light paths.

2. The apparatus of claim 1, wherein each of the at least one light source transmits light at different wavelengths.

3. The apparatus of claim 1, wherein the plurality of optical structures may be at least one of a diffractive optical structure, a reflective optical structure, and a refractive optical structure.

4. The apparatus of claim 1, wherein one or more of the plurality of optical structures comprise a grating with grating lines spaced in a manner to enable various images to appear on the user interface.

5. The apparatus of claim 1, wherein the plurality of optical structures are disposed in more than one direction.

6. The apparatus of claim 1, wherein the plurality of optical structures are disposed so that at least one optical structure is disposed parallel to at least one of the at least one light source and at least one optical structure disposed perpendicular to at least one of the at least one light source.

7. The apparatus of claim 1, wherein the at least one or more light sources are positioned perpendicular to each other.

8. The apparatus of claim 1, further comprising:
a lighting controller that controls operation of the at least one light source in order to display a desired image on the user interface.

9. A mobile communication device, comprising:
a casing for housing components of the mobile communication device;
a planar lightguide;
at least one light source located adjacent to the planar lightguide; and
a plurality of optical structures having at least a first section of optical structures disposed on the surface of the planar lightguide and a second section of optical structures disposed on the surface of the planar lightguide separate from the first section of optical structures;
wherein the first section of optical structures is configured to cause a first boundary behavior of light associated with the bending of light paths, and the second section of optical structures is configured to cause a second boundary behavior of light associated with the bending of light paths.

10. The mobile communication device of claim 9, wherein each of the at least one light source transmits light at different wavelengths.

11. The mobile communication device of claim 9, wherein the plurality of optical structures may be at least one of a diffractive optical structure, a reflective optical structure, and a refractive optical structure.

12. The mobile communication device of claim 9, wherein one or more of the plurality of optical structures comprise a grating with grating lines spaced in a manner to enable various images to appear on the user interface.

13. The mobile communication device of claim 9, wherein one or more of the plurality of optical structures are disposed in more than one direction.

14. The mobile communication device of claim 9, wherein the plurality of optical structures are disposed so that at least one optical structure is disposed parallel to at least one of the at least one light source and at least one optical structure disposed perpendicular to at least one of the at least one light source.

15. The mobile communication device of claim 9, wherein the at least one or more light sources are positioned perpendicular to each other.

16. The mobile communication device of claim 9, further comprising
a lighting controller that controls operation of the at least one light source in order to display a desired image on the user interface.

17. The mobile communication device of claim 9, wherein the mobile communication device may be one of a portable MP3 player, satellite radio receiver, AM/FM radio receiver, satellite television, portable music player, e-book, portable laptop, portable computer, wireless radio, wireless telephone, portable digital video recorder, cellular telephone, mobile telephone, and personal digital assistant.

18. A method of fabricating a user interface for a mobile communication device, comprising:
disposing at least one light source adjacent to a planar lightguide; and
disposing a plurality of optical structures having at least a first section of optical structures disposed on the surface of the planar lightguide and a second section of optical structures disposed on the surface of the planar lightguide separate from the first section of optical structures;
wherein the first section of optical structures is configured to cause a first boundary behavior of light associated with the bending of light paths, and the second section of optical structures is configured to cause a second boundary behavior of light associated with the bending of light paths.

19. The method of claim 18, wherein the plurality of optical structures may be at least one of a diffractive optical structure, a reflective optical structure, and a refractive optical structure.

20. The method of claim 18, wherein one or more of the plurality of optical structures comprise a grating with grating lines spaced in a manner to enable various images to appear on the user interface.
